(19) United States
(12) Patent Application Publication
(10) Pub. No.: US 2008/0059388 A1
(43) Pub. Date: Mar. 6, 2008

(54) WIRELESS POSITIONING METHOD USING FUZZY LOGIC

(75) Inventors: Sang Yub LEE, Gyunggi-do (KR); Chang Soo YANG, Gyunggi-do (KR); Wan Cheol YANG, Gyunggi-do (KR); Man Suk SEO, Gyunggi-do (KR)

Correspondence Address: LOWE HAUPTMAN HAM & BERNER, LLP, 1700 DIAGONAL ROAD, SUITE 300, ALEXANDRIA, VA, 22314, US

(73) Assignee: SAMSUNG ELECTRO-MECHANICS CO., LTD., GYUNGGI-DO (KR)

(21) Appl. No.: 11/847,829

(22) Filed: Aug. 30, 2007

(30) Foreign Application Priority Data
Aug. 31, 2006 (KR) 10-2006-83576

(51) Int. Cl. G06N 7/02

(52) U.S. Cl. 706/7

(57) ABSTRACT

A wireless positioning method includes determining a plurality of reference positions, locating a device on each of the plurality of reference positions, and obtaining a FIMF for a count value obtained by counting a time of arrival between the device on the each reference position and each anchor; obtaining an EOMF for the each reference position by using the FIMF for the each reference position; obtaining a FIMF for a count value between the device and the each anchor and obtaining an EOMF for the device by using the FIMF for the device when positioning of the device is started; determining a reference position having an EOMF most similar to that of the device from the plurality of reference positions, as a basic reference position; and calculating a position of the device by comparing a FIMF of the basic reference position with the FIMF of the device.

### CROSS-REFERENCE TO RELATED APPLICATIONS

This application claims the priority of Korean Patent Application No. 2006-0083576 filed on Aug. 31, 2006, in the Korean Intellectual Property Office, the disclosure of which is incorporated herein by reference.

### BACKGROUND OF THE INVENTION

1. Field of the Invention

The present invention relates to a wireless positioning method, and more particularly, to a wireless positioning method capable of accurately and simply recognizing a position of an object by using fuzzy logic.

2. Description of the Related Art

In general, depending on scope capable of providing positioning services, positioning technology using a wireless communication method is divided into macro positioning systems providing positioning services in very broad areas and micro positioning systems providing positioning services in small areas such as an indoor environment. For example, as macro positioning system, there are Global Positioning Systems (GPSs) and mobile communication systems such as cellular phones and personal communication services (PCSs). Also, micro positioning systems have been developed in the form of applying various local communication systems in rooms, basements, or areas with buildings standing close together where it is difficult to apply macro positioning systems.

On the other hand, recently, there have been attempts to apply a fuzzy logic algorithm to wireless positioning systems. However, this is limited to macro positioning systems directly measuring a distance. Also, since micro positioning systems counts time of arrival (TOA) between communication devices in wireless communication by using a clock and measures a distance using a count value, there is a limitation on application of conventionally known positioning methods using fuzzy logic.

Therefore, a positioning method capable of improving accuracy of position recognition and reducing complexity of a system by using the fuzzy logic, and more particularly, capable of being applied to micro positioning systems has been required in the art.

### SUMMARY OF THE INVENTION

An aspect of the present invention provides a wireless positioning method using fuzzy logic, the method capable of improving accuracy of position recognition and reducing complexity of the position recognition.

According to an aspect of the present invention, there is provided a wireless positioning method using fuzzy logic, in which a position of a device that is an object of positioning is recognized by detecting a distance by counting a time of arrival between the device and each of a plurality of fixed anchors, the method including: determining a plurality of reference positions, locating the device on each of the plurality of reference positions, and obtaining a fuzzy input membership function for a count value between the device on the each reference position and the each anchor; obtaining an expected output membership function for the each reference position by using the fuzzy input membership function for the each reference position; obtaining a fuzzy input membership function for a count value obtained by a time of arrival between the device and the each anchor and obtaining an expected output membership function for the device by using the fuzzy input membership function for the device when positioning of the device is started; determining a reference position having an expected output membership function most similar to that of the device from the plurality of reference positions as a basic reference position; and calculating a position of the device by comparing a fuzzy input membership function of the basic reference position with the fuzzy input membership function of the device.

The fuzzy input membership function is determined by Equation 1

$$FIMF ( x ) = \{ \begin{matrix}0 , & x < a - b \\ \frac{1}{b - c} ( x - ( a - b ) ) , & a - b \leq x < a - c \\ 1 , & a - c \leq x < a + c \\ \frac{- 1}{b - c} ( x - ( a + b ) ) , & a + c \leq x \leq a + b \\ 0 , & a + b \leq x\end{matrix} \qquad Equation 1$$

where “a” is an average of count values, “b” is a dispersion value of the count value, and “c” is a standard deviation value of the count value.

The expected output membership function is determined by Equation 2

$$EOMF ( x ) = \{ \begin{matrix}0 , & x < f - Δ f \\ \frac{1}{Δ f} ( x - ( f - Δ f ) ) , & f - Δ f \leq x < f \\ \frac{- 1}{Δ f} ( x - ( f + Δ f ) ) , & f \leq x < f + Δ f \\ 0 , & f + Δ f \leq x\end{matrix} \qquad Equation 2$$

where “f” is a center point of a line segment connecting points to one another, the points where the expected output membership function is located at an X-axis, and “Δf” is a distance between “f” and the point where the expected output membership function is located at an X-axis. The “f” may be determined to include an area in which the fuzzy input membership function of the each of the plurality of anchors is overlapped with one another, to the utmost. The “Δf” may be 1 to improve accuracy of position recognition.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a flowchart illustrating a wireless positioning method according to an exemplary embodiment of the present invention;

FIG. 2 is a conceptual diagram illustrating an environment where the positioning method is applied;

FIG. 3 is a graph illustrating a distribution of general fuzzy input membership functions; and

FIG. 4 is a graph illustrating an example of FIMFs and EOMF determined in one reference position according to an exemplary embodiment of the present invention.

### DETAILED DESCRIPTION OF THE PREFERRED EMBODIMENT

Hereinafter, exemplary embodiments of the present invention will now be described in detail with reference to the accompanying drawings. However, there may be various changes in the embodiments of the present invention. The present invention will not be defined by the embodiments as follows. The embodiments are provided so that this disclosure will be thorough and complete, and will fully convey the concept of the invention to those skilled in the art. Also, terms defined in the description are defined by considering functions in the embodiments. These may vary with intentions or usages of those skilled in the art. Therefore, the terms should not be understood as meanings to define technical elements.

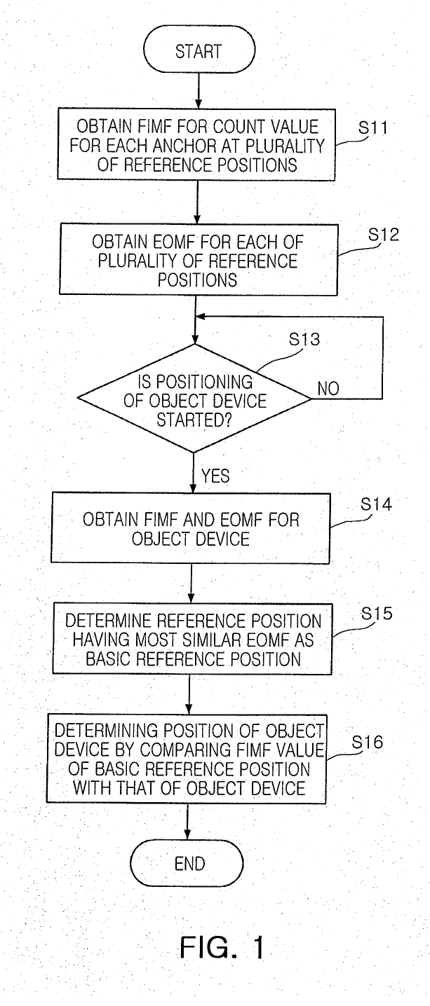

FIG. 1 is a flowchart illustrating a wireless positioning method according to an exemplary embodiment of the present invention.

Referring to FIG. 1, the wireless positioning method includes determining a plurality of reference positions and obtaining fuzzy input membership functions (FIMFs) for count values of a plurality of anchors in each of the reference positions (S11), obtaining an expected output membership function (EOMF) for the each reference position by using the FIMF (S12), when positioning for a device that is an object is started (S13), obtaining an FIMF for a count value of each of the anchor with respect to the device and an EOMF for the device by using the FIMF for the device (S14), determining a reference position having an EOMF most similar to the EOMF of the device from the EOMFs of the plurality of reference positions, as a basic reference position (S15), and calculating a position of the device by comparing the FIMF of the basic reference position with the FIMF of the device (S16).

The operations of the positioning method will be described in detail with reference to the attached drawings.

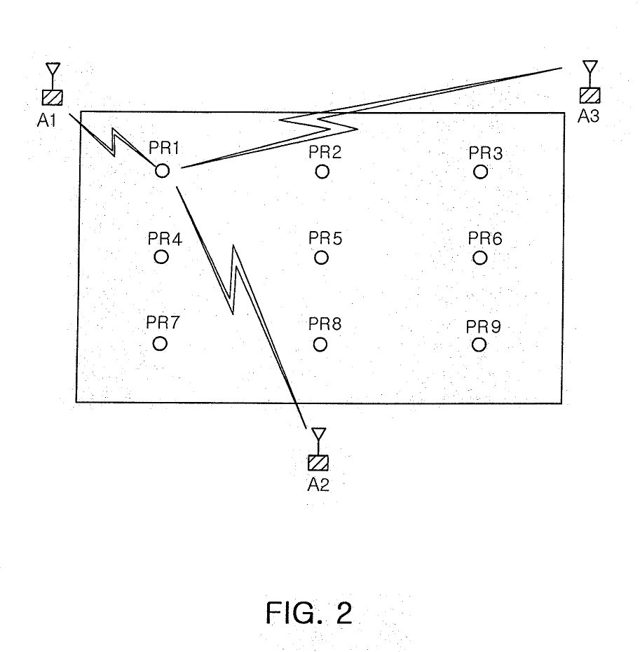

FIG. 2 is a conceptual diagram illustrating an environment where the positioning method is applied.

Referring to FIG. 2, to perform the positioning method, a plurality of reference positions RP1 to RP9 and a plurality of anchors A1 to A3 with a fixed position to wirelessly communicate with a device that is an object of positioning are required in a zone for performing position recognition.

In an environment for positioning shown in FIG. 2, the plurality of reference positions RP1 to RP9 are determined, the device for communicating with the anchors A1 to A3 is located in the reference positions RP1 to RP9, an FIMF for a count value of each of the anchors A1 to A3 in each of the reference positions RP1 to RP9 via wireless communication between the device and the anchors A1 to A3 is obtained (S11).

In FIG. 2, a number of the reference positions RP1 to RP9 and positions thereof may be voluntarily determined by a user depending on a state of the environment for applying the positioning method. Also, a number of the anchors A1 to A3 and positions thereof may be voluntarily determined by the user. However, to determine a two-dimensional position of the device, the number of the anchors A1 to A3 may be at least three.

Ahead of recognizing a position of the device, by analyzing communication between the device and the anchors A1 to A3 when the device is located in each of the reference positions RP1 to RP9, an FIMF for a count value for a corresponding reference position is obtained. The FIMF is determined by an average, dispersion, and a standard deviation, as shown in Equation 1.

$$FIMF ( x ) = \{ \begin{matrix}0 , & x < a - b \\ \frac{1}{b - c} ( x - ( a - b ) ) , & a - b \leq x < a - c \\ 1 , & a - c \leq x < a + c \\ \frac{- 1}{b - c} ( x - ( a + b ) ) , & a + c \leq x \leq a + b \\ 0 , & a + b \leq x\end{matrix} \qquad Equation 1$$

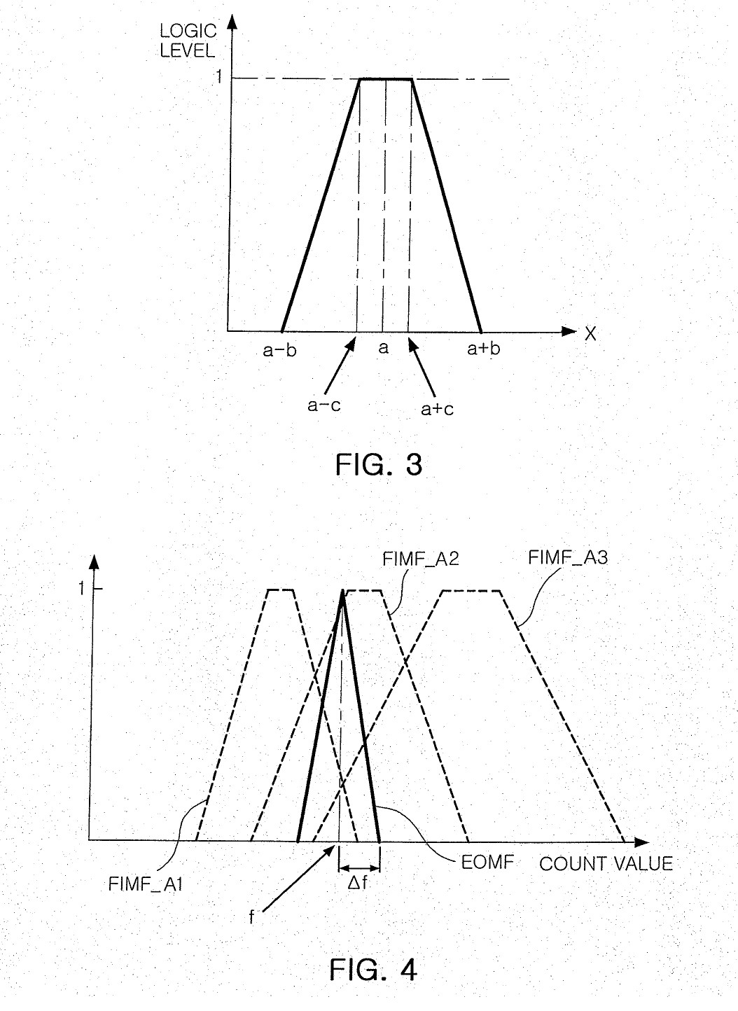

FIG. 3 is a graph illustrating Equation 1. As shown in FIG. 3, the FIMF in Equation 1 is shown in an isosceles trapezoid shape bisymmetrical on an average “a”. The FIMF is located at two points on an X-axis, in which the two points are a value obtained by subtracting a dispersion value “b” from the average “a” and a value obtained by adding the average “a” to the dispersion value “b”, respectively. Equation 1 illustrates a logic level of fuzzy logic depending on the average “a”, the dispersion value “b”, and a standard deviation value “c”. The distribution of the level of the fuzzy logic is well-known to those skilled in the art. Therefore, a detailed description will be omitted.

As described above, after a signal is transmitted from the anchor to the device via a plurality of times of communication the device located on the each reference position and the anchor, a time for receiving a response for the signal is counted for a plurality of times, and an average, dispersion, and a standard deviation of a count value is operated, thereby obtaining the FIMF for the each reference positions.

An EOMF is obtained by using the FIMF for the each reference position (S12). FIG. 4 is a graph illustrating an example of an FIMF and EOMF determined in one reference position according to an exemplary embodiment of the present invention. Particularly, as shown in FIG. 2, three anchors are used. As dotted lines shown in FIG. 4, three anchors are used and an FIMF in association with each of the three anchors is obtained at one reference position, thereby generating three FIMFs FIMF_A1 to FIMF_A3. On the other hand, an EOMF may be as shown in Equation 2, which is shown as an isosceles triangle shape in a solid line in FIG. 4.

$$EOMF ( x ) = \{ \begin{matrix}0 , & x < f - Δ f \\ \frac{1}{Δ f} ( x - ( f - Δ f ) ) , & f - Δ f \leq x < f \\ \frac{- 1}{Δ f} ( x - ( f + Δ f ) ) , & f \leq x < f + Δ f \\ 0 , & f + Δ f \leq x\end{matrix} \qquad Equation 2$$

In Equation 2, “f” is a center point of a base line of the isosceles triangle, namely, a center point of a line segment formed by points where the EOMF is located at an X-axis, “Δf” is a distance between the center point and a vertex neighboring the same. Generally, “Δf” of the EOMF is voluntarily determined by a user. “f” of the EOMF is determined at a position capable of including a broadest portion of overlapping isosceles trapezoids formed by the plurality of FIMFs with the isosceles triangle formed by the EOMF.

Accuracy of positioning may be adjusted by properly determining a value of “Δf”. That is, the larger the value of “Δf”, the larger a size of the triangle formed by the EOMF. Accordingly, an error allowed when determining the EOMF becomes larger. The smaller the value of “Δf”, the smaller the size of the triangle formed by the EOMF. Accordingly, the error allowed when determining the EOMF becomes smaller. Therefore, the error may be reduced to be a distance corresponding to one count value by determining the value of “Δf” as 1.

As described above, ahead of recognizing a real position of the device, FIMFs and EOMFs at a plurality of reference positions are obtained. When positioning of a device that is an object of real position recognition is started (S13), as in the same way described above, a time of arrival (TOA) between a plurality of anchors and the device is counted, an FIMF for a count value is obtained, and an EOMF is obtained by using the FIMF (S14). That is, a TOA when the object device wireless communicates with each of the anchors is counted by a plurality of times and an FIMF for a count value is obtained with respect to the each anchor by using an average, dispersion, and a standard deviation of the count value. Also, an EOMF having a value of “f” on a position capable of including a broadest portion of overlapping a plurality of FIMFs is obtained.

Among EOMFs of the plurality of reference positions, a reference position having an EOMF most similar or identical to that of the device that is the real object of positioning is determined as a basic reference position (S15). Since a most similar count value for an anchor is detected at a reference position most adjacent to the device, most similar FIMF and EOMF may be also detected. That is, in S15, the reference position most adjacent to the device is determined as the base reference position applied to position recognition.

A position of the device is calculated by comparing an FIMF of the based reference position with the FIMF of the device (S16). In more detail, after comparing an average count value with respect to each anchor at the base reference position with an average count value of the device with respect to the each anchor, the position is adjusted from the basic reference position according to a difference of the count values, thereby simply detecting the position of the device.

As described above, previously obtaining an FIMF of a count value for a TOA between a plurality of reference positions RP1 to RP9 and each of anchors A1 to A3 and an EOMF at each of the reference positions RP1 to RP9 by using the FIMF, when positioning of a real device is started, and the FIMF and EOMF previously obtained at the reference position are compared with an FIMF and EOMF of the device that is an object of positioning, thereby simply recognizing a position of the device. Also, a size of a value of “Δf” in a value of an EOMF used for positioning is changed, thereby properly adjusting accuracy of positioning. Particularly, when the value of “Δf” is determined as one that is a minimum count value, the positioning may be performed by accuracy with a minimum error of a distance corresponding to one count value.

As described above, according to the present invention, FIMFs and EOMFs of reference positions and a device that is an object of positioning are obtained and compared with each other by applying fuzzy logic to wireless positioning technologies, thereby recognizing positions via simple operations. Also, via this, complexity of a system for positioning may be reduced.

Also, accuracy of the positioning may be adjusted by controlling a value of “Δf” in the EOMF, and an error of the positioning may be reduced by determining the value of “Δf” as a minimum count value.

While the present invention has been shown and described in connection with the exemplary embodiments, it will be apparent to those skilled in the art that modifications and variations can be made without departing from the spirit and scope of the invention as defined by the appended claims.

What is claimed is:

1. A wireless positioning method using fuzzy logic, in which a position of a device that is an object of positioning is recognized by detecting a distance by counting a time of arrival between the device and each of a plurality of fixed anchors, the method comprising:
determining a plurality of reference positions, locating the device on each of the plurality of reference positions, and obtaining a fuzzy input membership function for a count value between the device on the each reference position and the each anchor;
obtaining an expected output membership function for the each reference position by using the fuzzy input membership function for the each reference position;
obtaining a fuzzy input membership function for a count value obtained by counting a time of arrival between the device and the each anchor and obtaining an expected output membership function for the device by using the fuzzy input membership function for the device when positioning of the device is started;
determining a reference position having an expected output membership function most similar to that of the device from the plurality of reference positions, as a basic reference position; and
calculating a position of the device by comparing a fuzzy input membership function of the basic reference position with the fuzzy input membership function of the device.

2. The method of claim 1, wherein the fuzzy input membership function is determined by Equation 1
$$FIMF ( x ) = \{ \begin{matrix}0 , & x < a - b \\ \frac{1}{b - c} ( x - ( a - b ) ) , & a - b \leq x < a - c \\ 1 , & a - c \leq x < a + c \\ \frac{- 1}{b - c} ( x - ( a + b ) ) , & a + c \leq x \leq a + b \\ 0 , & a + b \leq x\end{matrix} \qquad Equation 1$$
where “a” is an average of count values, “b” is a dispersion value of the count value, and “c” is a standard deviation value of the count value.

3. The method of claim 1, wherein the expected output membership function is determined by Equation 2 in which “f” is determined to include an area in which the fuzzy input membership function of the each of the plurality of anchors is overlapped with one another to the utmost
$$EOMF ( x ) = \{ \begin{matrix}0 , & x < f - Δ f \\ \frac{1}{Δ f} ( x - ( f - Δ f ) ) , & f - Δ f \leq x < f \\ \frac{- 1}{Δ f} ( x - ( f + Δ f ) ) , & f \leq x < f + Δ f \\ 0 , & f + Δ f \leq x\end{matrix} \qquad Equation 2$$
where “f” is a center point of a line segment connecting points to one another, the points where the expected output membership function is located at an X-axis, and “Δf” is a distance between “f” and the point where the expected output membership function is located at an X-axis.

4. The method of claim 3, wherein “Δf” is 1.
